(19) United States
(12) Patent Application Publication
(10) Pub. No.: US 2008/0241439 A1
(43) Pub. Date: Oct. 2, 2008

(54) HEAT-SENSITIVE TRANSFER RECORDING MATERIAL AND METHOD OF PRODUCING THE SAME

(75) Inventors: Kiyoshi IRITA, Ashigarakami-gun (JP); Yasuhisa Sano, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/056,091

(22) Filed: Mar. 26, 2008

(30) Foreign Application Priority Data
Mar. 28, 2007 (JP) 2007-085519

(51) Int. Cl. B41M 5/40

(52) U.S. Cl. 428/32.72

(57) ABSTRACT

A heat-sensitive transfer image-receiving sheet, containing, on a support, at least one dye-receptive layer containing latex polymer and at least one heat-insulating layer, at least said receptive layer and a layer adjacent thereto being formed by a water-based simultaneous multilayer coating method, wherein said sheet contains at least one solid dispersion having an average particle diameter of 1.0 g μm or less of at least one material selected from a compound represented by formula (L1) and wax:

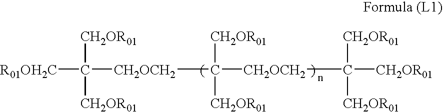

wherein R₀₁ represents —C(═O)R or a hydrogen atom, in which R represents an aliphatic group which may have a substituent, and a plurality of Rol 's are the same as or different from each other, but at least one of R₀₁'s is —C(═O)R; and n represents 0 or 1.

### FIELD OF THE INVENTION

The present invention relates to a heat-sensitive transfer recording material and a method of producing the same. More specifically, the present invention relates to a heat-sensitive transfer recording material which causes less surface state deficiency upon coating and by which a favorable image can be provided, and to a method of producing such the heat-sensitive transfer recording material.

### BACKGROUND OF THE INVENTION

Various heat transfer recording systems have been known so far. These systems attract attention as a process that can produce a color hard copy having an image quality closest to that of silver halide photography (see, for example, “Joho Kiroku (Hard Copy) to Sono Zairyo no Shintenkai (Information Recording (Hard Copy) and New Development of Recording Materials)” published by Toray Research Center Inc., 1993, pp. 241-285; and “Printer Zairyo no Kaihatsu (Development of Printer Materials)” published by CMC Publishing Co., Ltd., 1995, p. 180). Moreover, these systems have the following advantages over silver halide photography: that is, the system is a dry system, it enables direct visualization from digital data, it makes reproduction simple, and the like.

In these heat transfer recording systems, a heat-sensitive transfer sheet (hereinafter also referred to as an ink sheet) containing a dye(s) is superposed on a heat-sensitive transfer image-receiving sheet (hereinafter also referred to as an image-receiving sheet), and then the ink sheet is heated by a thermal head whose exothermic action is controlled by electric signals, in order to transfer the dye(s) contained in the ink sheet to the image-receiving sheet, thereby recording an image information. Three colors: cyan, magenta, and yellow, are used for recording a color image by overlapping one color to other, thereby enabling transferring and recording a color image having continuous gradation for color densities.

Hitherto, the heat-sensitive transfer recording material generally has been manufactured by an organic solvent-based coating system. Recently, from a concern about environmental load, it has been studied to manufacture the heat-sensitive transfer recording material by a non-organic solvent-based coating system, namely a water-based coating system. For example, in publications such as JP-A-2006-264085 (“JP-A” means unexamined published Japanese patent application), JP-A-2006- 264087, and JP-A-2006- 264092, there is disclosed a water-based coating system using gelatin as an example of layer-forming resins.

With the spread of a thermal transfer recording system, speeding-up of the printing speed is progressing. In order to obtain a satisfactory colored density for response to the demand, a method of applying a larger quantity of thermal energy than the conventional quantity at the time of printing is employed. Ordinarily, a thermoplastic polymer is used in a receptive layer of the image-receiving sheet. A compatibility of dye transfer property and releasing property from the ink sheet is made, by controlling a glass transition temperature (Tg) of the thermoplastic polymer. Generally, the lower the Tg is, the higher the transfer property is. In contrast, generally the higher the Tg is, the more difficult the heat seal becomes. However, the dye transfer property is becoming incompatible with the releasing property by the action of increasing a quantity of thermal energy given to the image-receiving sheet at the time of printing. Namely, there is a tendency that a dye transfer becomes difficult in the image-receiving sheet that is excellent in releasing property from the ink sheet, while release is becoming difficult in the image-receiving sheet that is excellent in the dye transfer property.

For resolving these problems, a method of introducing a releasing agent into a surface of the image-receiving sheet has been proposed. Japanese Patents No. 2572769 and No. 2854319 describe releasing agents, such as polyethylene wax, amide wax, and Teflon (registered trade mark) powder, each of which is to be added to a receptive layer of the heat-sensitive transfer image-receiving sheet. JP-A-11-321139 describes a method of introducing a carnauba wax into a receptive layer composed of a certain polyester compound. This publication also describes that introduction of the camauba wax enables to effectively prevent sticking from occurring and also to improve releasing property from the ink sheet.

JP-A-2005-238748 describes a method of introducing a urethane-modified wax into the image-receiving sheet, thereby to attain both enhancement of transfer density and releasing property from the ink sheet. However, if the image-receiving sheet containing a solid dispersion is prepared as described in these patent publications, cissing and contaminant on the coated surface of the coating layer are found in many cases. Therefore, so-called “surface state deficiency” is apt to occur, so that it is difficult to obtain a high quality image. Such the problems especially become conspicuous in the case where the image-receiving sheet is prepared according to a simultaneous multilayer coating method. In order to resolve the above-described problems, it has been desired to develop a technology for preventing the coated surface state from deterioration.

### SUMMARY OF THE INVENTION

The present invention resides in a heat-sensitive transfer image-receiving sheet, which contains, on a support, at least one dye-receptive layer containing latex polymer and at least one heat-insulating layer, at least said receptive layer and a layer adjacent thereto being formed by a water-based simultaneous multilayer coating method, wherein said sheet contains at least one solid dispersion having an average particle diameter of 1.0 μm or less of at least one material selected from a compound represented by formula (L1) and wax:

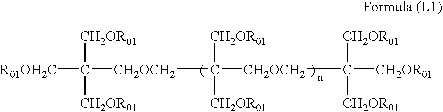

wherein R₀₁ represents —C(═O)R or a hydrogen atom, in which R represents an aliphatic group which may have a substituent, and a plurality of Rol's are the same as or different from each other, but at least one of R₀₁'s is —C(═O)R; and n represents 0 or 1.

Other and further features and advantages of the invention will appear more fully from the following description.

### DETAILED DESCRIPTION OF THE INVENTION

According to the present invention, there is provided the following means:
(1) A heat-sensitive transfer image-receiving sheet, comprising, on a support, at least one dye-receptive layer containing latex polymer and at least one heat-insulating layer, at least said receptive layer and a layer adjacent thereto being formed by a water-based simultaneous multilayer coating method, wherein said sheet contains at least one solid dispersion having an average particle diameter of 1.0 μm or less of at least one material selected from a compound represented by formula (L1) and wax:

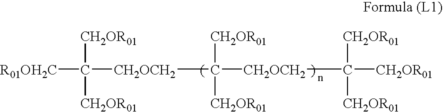

wherein R₀₁ represents —C(═O)R or a hydrogen atom, in which R represents an aliphatic group which may have a substituent, and a plurality of Rol's are the same as or different from each other, but at least one of R₀₁'s is —C(═O)R; and n represents 0 or 1.
(2) The heat-sensitive transfer image-receiving sheet as described in the above item (1), wherein an average particle diameter of the entire solid dispersions contained in coating liquids for forming constitutional layers on the same side as the dye-receptive layer on the support is 1.0 μm or less.
(3) The heat-sensitive transfer image-receiving sheet as described in the above item (1) or (2), wherein in terms of particle diameter of the entire solid dispersions contained in coating liquids for forming constitutional layers on the same side as the dye-receptive layer on the support, the number of particles of not less than 10 μm is 1/500 or less with respect to the total particle numbers.
(4) The heat-sensitive transfer image-receiving sheet as described in any one of the above items (1) to (3), wherein said dye-receptive layer contains latex polymer containing at least one recurring unit obtained from vinyl chloride.
(5) The heat-sensitive transfer image-receiving sheet described in any one of the above items (1) to (4), wherein said latex polymer of the dye-receptive layer is latex polymer containing at least one recurring unit obtained from vinyl chloride and at least one recurring unit obtained from acrylic acid ester.
(6) The heat-sensitive transfer image-receiving sheet described in any one of the above items (1) to (5), wherein said at least one heat-insulating layer on the support contains hollow polymer particles.
(7) The heat-sensitive transfer image-receiving sheet described in any one of the above items (1) to (6), wherein said heat-insulating layer contains at least one water-soluble polymer.
(8) The heat-sensitive transfer image-receiving sheet as described in the above item (7), wherein said water-soluble polymer is gelatin or polyvinyl alcohol.

The present invention is explained in detail below.

First, the compound represented by formula (L1) for use in the present invention is explained in detail.

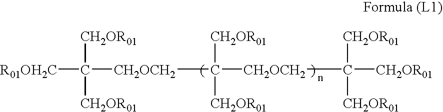

In the formula, R₀₁ represents —C(═O)R or a hydrogen atom, wherein R represents an aliphatic group which may have a substituent. A plurality of R₀₁'s existing in the formula may be the same as or different from each other, but at least one of R₀₁'s is —C(═O)R. n represents 0 or 1.

R in R₀₁ represents an aliphatic group. Said aliphatic group may be a straight chain, branched, or cyclic aliphatic group, which may be saturated or unsaturated, and may have a substituent. As the aliphatic group, preferred are an alkyl group, an alkenyl group, an alkynyl group, a cycloalkyl group, or a cycloalkenyl group, each of which may have a substituent. Of these groups, more preferred is an alkyl group or an alkenyl group. The carbon atom number of said aliphatic group is preferably from 1 to 60, but the carbon number of the unsaturated aliphatic group is preferably from 2 to 60, the carbon number of the cycloalkyl group is preferably from 3 to 60 (more preferably from 5 to 60), and the carbon number of the cycloalkenyl group is preferably from 5 to 60. The carbon number of R is preferably from 3 to 50, more preferably from 5 to 50, further more preferably from 7 to 50, and most preferably from II to 30.

Examples of the substituent which the aliphatic group may have, include an aliphatic group, an aromatic group, a heterocyclic group (as the hetero ring moiety in said group, a 5- to 8-membered ring is preferred, and a 5- or 6-membered ring is more preferred; and the ring preferably contains any one of an oxygen atom, a sulfur atom or a nitrogen atom as a ring-forming atom; and further, the ring may be condensed with an alicyclic ring, an aromatic ring, or a hetero ring, or may have a substituent.), a halogen atom, a hydroxyl group, a mercapto group, a cyano group, a nitro group, a sulfo group, a carboxyl group, a sulfonyl group, a sulfinyl group, an amino group, an aliphatic amino group, an aromatic amino group, a heterocyclic amino group, an aliphatic oxy group, an aromatic oxy group, a heterocyclic oxy group, an aliphatic thio group, an aromatic thio group, a heterocyclic thio group, an acyl group, an acylamino group, an sulfonamido group, a sulfamoyl group, a carbamoyl group, an imido group, an acyloxy group, a ureido group, a urethane group, and an aliphatic or aromatic oxycabonyl group. Of these substituents, preferred are an aliphatic group, a hydroxyl group, an amino group, an aliphatic amino group, an acylamino group, a sulfonamido group, an acyloxy group, and an aliphatic oxy group. An aliphatic group, a hydroxyl group, and an amino group are more preferred.

Besides, R is preferably an unsubstituted aliphatic group.

Specific examples of —C(═O)R include groups of octanoyl, t-octanoyl, i-octanoyl, nonanoyl, isononanoyl, lauroyl, myristoyl, palmitoyl, stearoyl, isostearoyl, docosanoyl, oleoyl, 13-docosynoyl, and hydroxystearoyl.

In the present invention, at least one compound represented by formula (L1) is to be incorporated into the image-receiving sheet. A plurality of compounds represented by formula (L1) are also preferably incorporated. Namely, it is also a preferable embodiment to incorporate the compounds represented by formula (L1) as a mixture thereof.

More specifically, of the compounds represented by formula (L1), preferred are those produced by acylating the compound in which each of Rol's in formula (L1) is a hydrogen atom.

Acylation may be performed with a single acylating agent (R in —C(═O)R is single), or alternatively with a plurality of acylating agents (Rs in —C(═O)R are plural kinds, preferably two kinds). In that case, a ratio of acylated OH groups to all the OH groups of alcohol derivatives (dierythritol or trierythritol) of the above described raw materials is indicated as a substitution degree, assuming that the substitution degree be 100 in the case where all the OH groups have been acylated. The substitution degree is preferably from 50 to 100, more preferably from 60 to 100, furthermore preferably from 70 to 100, still more preferably from 80 to 100, still furthermore preferably from 90 to 100, and most preferably 100.

R's in a plurality of R₀₁'s are preferably the same as each other.

Examples of the acylating agent include RC(═O)X, wherein X represents OH, OR_{A}, or OC(═O)R_{B}, and R_{A} represents an alkyl group or an aryl group, and R_{B} represents an aliphatic group. The acylating agent can be synthesized easily, according to an ordinary esterification reaction.

A molecular mass of the compound represented by formula (L1) is preferably from 900 to 4,000, more preferably from 1,000 to 3,000.

Specific examples of the compound represented by formula (L1) for use in the present invention are shown below, but the invention is not limited to those compounds.

TABLE 1

| Compound | | | Substitution | | Substitution | | Substitution | Molecular |
|---|---|---|---|---|---|---|---|---|
| No. | n | R₀₁ | degree | R₀₁ | degree | R₀₁ | degree | mass |
| L1-101 | 0 | stearoyl | 100 | — | — | — | — | 1850 |
| L1-102 | 0 | stearoyl | 83 | hydrogen atom | 17 | — | — | 1568 |
| L1-103 | 0 | stearoyl | 67 | hydrogen atom | 33 | — | — | 1286 |
| L1-104 | 0 | isostearoyl | 50 | isooctanoyl | 50 | — | — | 1430 |
| L1-105 | 0 | stearoyl | 50 | isostearoyl | 50 | — | — | 1850 |
| L1-106 | 0 | hydroxylstearoyl | 67 | stearoyl | 33 | — | — | 1914 |
| L1-107 | 0 | hydroxylstearoyl | 33 | isostearoyl | 33 | hydrogen atom | 34 | 1318 |
| L1-108 | 0 | hydroxylstearoyl | 50 | isostearoyl | 50 | — | — | 1898 |
| L1-109 | 0 | isostearoyl | 50 | myristoyl | 50 | — | — | 1682 |
| L1-110 | 0 | isostearoyl | 83 | isononanoyl | 17 | — | — | 1724 |
| L1-111 | 0 | isooctanoyl | 50 | myristoyl | 50 | — | — | 1262 |
| L1-112 | 0 | hydroxystearoyl | 67 | oleoyl | 33 | — | — | 1910 |
| L1-113 | 0 | isostearoyl | 67 | oleoyl | 17 | hydrogen atom | 16 | 1566 |
| L1-114 | 0 | isostearoyl | 50 | docosanoyl | 17 | hydrogen atom | 33 | 1390 |
| L1-115 | 1 | isostearoyl | 100 | — | — | — | — | 2500 |
| L1-116 | 1 | isostearoyl | 88 | hydrogen atom | 12 | — | — | 2246 |
| L1-117 | 1 | isostearoyl | 75 | hydrogen atom | 25 | — | — | 1964 |
| L1-118 | 1 | isostearoyl | 50 | isooctanoyl | 50 | — | — | 1968 |
| L1-119 | 1 | isooctanoyl | 50 | myristoyl | 50 | — | — | 1744 |
| L1-120 | 1 | hydroxylstearoyl | 75 | oleoyl | 25 | — | — | 2620 |

The term wax that can be used in the present invention embraces not only an ester of a fatty acid and a water-insoluble higher alcohol in a narrow sense, but also materials that are called a wax in a broad sense. Examples of the latter include montan wax and paraffin wax. One of purposes for using these waxes is to prevent heat seal at the time of printing. They are used in the form of a solid dispersion. Adding a few words about it for precaution's sake, the hollow polymer particles for use in the present invention is not included in the solid dispersion that is used in the present invention.

In the heat-sensitive transfer image-receiving sheet of the present invention, at least a dye receptive layer (a receptive layer) and a heat-insulating layer are provided on or over a substrate (hereinafter, also referred to as a support, in some cases). Further, an interlayer may be formed between the support and the heat-insulating layer. For example, any of a white background control layer, a charge-control layer, an adhesive layer, and a primer layer can be formed. It is preferable that a curling-control layer, a writing layer, or a charge-control layer be formed on the backside of the support. Each layer may be coated by a method capable of simultaneously coating multi layers, such as slide coat and curtain coat. Of these coating methods, the slide coat is more preferred.

### (Receptive Layer)

The receptive layer performs functions of receiving dyes transferred from an ink sheet and retaining an image formed. The image-receiving sheet of the present invention has at least one receptive layer preferably containing at least one thermoplastic receiving polymer that can receive a dye. Further, the receptive layer preferably contains a solid dispersion that is explained in the present specification.

The receptive polymer is preferably used in the form of latex polymer in which the polymer is dispersed in an aqueous dispersion medium. Further, the receptive layer preferably contains a water soluble polymer (which is described in detail in the below) in addition to the latex polymer. In the receptive layer, the latex polymer that is used as a receptive polymer can be used together with another functional latex polymer for purposes, such as regulation of elastic coefficient of the film. The receptive layer may be a single layer or double or more multi-layers.

<Latex polymer>

The latex polymer (polymer latex) that can be used in the present invention is explained.

In the heat-sensitive transfer image-receiving sheet of the present invention, the latex polymer that can be used in the receptive layer is a dispersion in which a water-insoluble hydrophobic polymer is dispersed as fine particles in a water-soluble dispersion medium. The latex polymer is not particularly limited, so far as at least one thermoplastic polymer having receptivity of a dye transferred from a dye-transfer material is used. It is one preferable embodiment to use at least one latex polymer containing at least one monomer unit obtained from vinyl chloride, namely at least one recurring unite obtained from vinyl chloride. Further, several different kinds of latex polymers may be used in combination.

The dispersed state may be one in which polymer is emulsified in a dispersion medium, one in which polymer underwent emulsion polymerization, one in which polymer underwent micelle dispersion, one in which polymer molecules partially have a hydrophilic structure and thus the molecular chains themselves are dispersed in a molecular dispersion state, or the like. Latex polymers are described in “Gosei Jushi Emulsion (Synthetic Resin Emulsion)”, compiled by Taira Okuda and Hiroshi Inagaki, issued by Kobunshi Kanko Kai (1978); “Gosei Latex no Oyo (Application of Synthetic Latex)”, compiled by Takaaki Sugimura, Yasuo Kataoka, Souichi Suzuki, and Keishi Kasahara, issued by Kobunshi Kanko Kai (1993); Soichi Muroi, “Gosei Latex no Kagaku (Chemistry of Synthetic Latex)”, issued by Kobunshi Kanko Kai (1970); Yoshiaki Miyosawa (supervisor) “Suisei Coating-Zairyo no Kaihatsu to Oyo (Development and Application of Aqueous Coating Material)”, issued by CMC Publishing Co., Ltd. (2004) and JP-A-64-538, and so forth. In the present invention, the average particle diameter of the dispersed particles is preferably in the range of approximately 1 to 50,000 nm, more preferably 5 to 1,000 nm.

The latex polymer for use in the present invention may be latex of the so-called core/shell type, other than ordinary latex polymer of a uniform structure. When using a core/shell type latex polymer, it is preferred in some cases that the core and the shell have different glass transition temperatures. The glass transition temperature (Tg) of the latex polymer for use in the present invention is preferably −30° C. to 100° C. , more preferably 0° C. to 80° C., further more preferably 10° C. to 70° C., and especially preferably 15° C. to 60° C.

In the present invention, another latex polymer that can be used in combination with the latex polymer containing a repeating unit derived from vinyl chloride (vinyl chloride-based latex) is not particularly limited, but hydrophobic polymers, such as acrylic-series polymers, polyesters, rubbers (e.g., SBR resins), polyurethanes, polyvinyl chlorides, polyvinyl acetates, polyvinylidene chlorides, and polyolefins, are preferably used. These polymers may be straight-chain, branched, or cross-linked polymers, the so-called homopolymers obtained by polymerizing single type of monomers, or copolymers obtained by polymerizing two or more types of monomers.

As preferable embodiments of a latex polymer containing a repeating unit derived from vinyl chloride used in the receptive layer in the present invention, use may be preferably made of a polyvinyl chloride, a copolymer comprising vinyl chloride monomer unit, such as a vinyl chloride/vinyl acetate copolymer and a vinyl chloride/acrylate copolymer. In case of the copolymer, the vinyl chloride unit in molar ratio is preferably in the range of from 50 mass % to 95 mass %. These polymers may be straight-chain, branched, or cross-linked polymers, the so-called homopolymers obtained by polymerizing single type of monomers, or copolymers obtained by polymerizing two or more types of monomers. In the case of the copolymers, these copolymers may be either random copolymers or block copolymers. The molecular mass of each of these polymers is preferably 5,000 to 1,000,000, and further preferably 10,000 to 500,000 in terms of number average molecular mass. Polymers having excessively small molecular mass impart insufficient dynamic strength to the layer containing the latex, and polymers having excessively large molecular mass bring about poor film-forming ability. Crosslinkable latex polymers are also preferably used.

The latex polymer containing a repeating unit derived from vinyl chloride that can be used in the present invention is commercially available, and polymers described below may be utilized. Examples thereof include G351 and G576 (trade names, manufactured by Nippon Zeon Co., Ltd.); VINYBLAN 240, 270, 277, 375, 386, 609, 550, 601, 602, 630, 660, 671, 683, 680, 680S, 681N, 685R, 277, 380, 381, 410, 430, 432, 860, 863, 865, 867, 900, 90OGT, 938 and 950 (trade names, manufactured by Nissin Chemical Industry Co., Ltd.).

Latex polymers that can be used in combination are also commercially available, and polymers described below may be utilized. Examples of the acrylic-series polymers include Cevian A-4635, 4718, and 4601 (trade names, manufactured by Daicel Chemical Industries); Nipol Lx811 , 814, 821, 820, 855 (P-17: Tg 36° C.), and 857×2 (P-18: Tg 43° C.) (trade names, manufactured by Nippon Zeon Co., Ltd.); Voncoat R3370 (P-19: Tg 25° C.), and 4280 (P-20: Tg 15° C.) (trade names, manufactured by Dai-Nippon Ink & Chemicals, Inc.); Julimer ET-410 (P-21: Tg 44° C.) (trade name, manufactured by Nihon Junyaku K. K.); AE116 (P-22: Tg 50° C.), AE119 (P-23: Tg 55° C.), AE121 (P-24: Tg 58° C.), AE125 (P-25: Tg 60° C.), AE134 (P-26: Tg 48° C.), AE137 (P-27: Tg 48° C.), AE140 (P-28: Tg 53° C.), and AE173 (P-29: Tg 60° C.) (trade names, manufactured by JSR Corporation); Aron A-104 (P-30: Tg 45° C.) (trade name, manufactured by Toagosei Co., Ltd.); NS-600X, and NS-620X (trade names, manufactured by Takamatsu Yushi K. K.); VINYBLAN 2580, 2583, 2641, 2770, 2770H, 2635, 2886, 5202C, and 2706 (trade names, manufactured by Nissin Chemical Industry Co., Ltd.).

Examples of the polyesters include FINETEX ES650, 611, 675, and 850 (trade names, manufactured by Dainippon Ink and Chemicals, Incorporated); WD-size, and WMS (trade names, manufactured by Eastman Chemical Ltd.); A-110, A-115GE, A-120, A-121, A-124GP, A-124S, A-160P, A-210 A-215GE, A-510, A-513E, A-515GE, A-520, A-610, A-613, A-615GE, A-620, WAC-10, WAC-15, WAC-17XC, WAC-20, S-110, S- 110EA, S-111SL, S-120, S-140, S-140A, S-250, S-252G, S-250S, S-320, S-680, DNS-63P, NS-122L, NS-122LX, NS-244LX, NS-140L, NS-141LX, and NS-282LX (trade names, manufactured by Takamatsu Yushi K.K.); Aronmelt PES-1000 series, and PES-2000 series (trade names, manufactured by Toagosei Co., Ltd.); Bironal MD-1100, MD-1200, MD-1220, MD-1245, MD-1250, MD-1335, MD-1400, MD-1480, MD-1500, MD-1930, and MD-1985 (trade names, manufactured by Toyobo Co., Ltd.); and Ceporjon ES (trade name, manufactured by Sumitomo Seika Chemicals Co., Ltd.).

Examples of the polyurethanes include HYDRAN APlO, AP20, AP30, AP40, and 101H, Vondic 1320NS and 1610NS (trade names, manufactured by Dainippon Ink and Chemicals, Incorporated); D-1000, D-2000, D-6000, D-4000, and D-9000 (trade names, manufactured by Dainichi Seika Color & Chemicals Mfg. Co., Ltd.); NS- I 55X, NS-310A, NS-310X, and NS-311X (trade names, manufactured by Takamatsu Yushi K. K.); Elastron (trade name, manufactured by Dai-ichi Kogyo Seiyaku Co., Ltd.).

Examples of the rubbers include LACSTAR 7310K, 3307B, 4700H, and 7132C (trade names, manufactured by Dainippon Ink & Chemicals Incorporated); Nipol Lx416, LX410, LX430, LX435, LX110, LX415A, LX438C, 2507H, LX303A, LX407BP series, V1004, and MH5055 (trade names, manufactured by Nippon Zeon Co., Ltd.).

Examples of the polyolefins include Chemipearl S120, SA100, and V300 (P-40: Tg 80° C.) (trade names, manufactured by Mitsui Petrochemical); Voncoat 2830, 2210, and 2960 (trade names, manufactured by Dainippon Ink and Chemicals, Incorporated); Zaikusen and Ceporjon G (trade names, manufactured by Sumitomo Seika Chemicals Co., Ltd.). Examples of the nylon copolymers include CeporjonPA (trade name, manufactured by Sumitomo Seika Chemicals Co., Ltd.) and so forth.

Examples of the polyvinyl acetates include VINYBLAN 1080, 1082, 1085W, 1108W, 1108S, 1563M, 1566, 1570, 1588C, A22J7-F2, 1128C, 1137, 1138, A20J2, A23J1, A23J1, A23K1, A23P2E, A68J1N, 1086A, 1086, 1086D, 1108S, 1187, 1241LT, 1580N, 1083, 1571, 1572, 1581, 4465, 4466, 4468W, 4468S, 4470, 4485LL, 4495LL, 1023, 1042, 1060, 1060S, 1080M, 1084W, 1084S, 1096, 1570K, 1050, 1050S, 3290, 1017AD, 1002, 1006, 1008, 1107L, 1225, 1245L, GV-6170, GV-6181, 4468W, and 4468S (trade names, manufactured by Nisshin Chemical Industry Co., Ltd.).

These latex polymers may be used singly, or two or more of these polymers may be blended, if necessary.

In the heat-sensitive transfer image-receiving sheet of the present invention, the latex polymer of the dye-receptive layer is preferably a latex polymer containing at least one recurring unit obtained from vinyl chloride and at least one recurring unit obtained from acrylic acid ester. In this latex polymer, the content of the recurring unit derived from vinyl chloride unit in molar ratio is preferably in the range of from 50 mol % to 99 mol %, more preferably from 60 mol % to 98 mol %.

The latex polymer for use in the present invention can be easily obtained by a solution polymerization method, a suspension polymerization method, an emulsion polymerization method, a dispersion polymerization method, an anionic polymerization method, a cationic polymerization method, or the like. Above all, an emulsion polymerization method in which the polymer is obtained as a latex is the most preferable. Besides, a method is preferable in which the polymer is prepared in a solution, and the solution is neutralized, or an emulsifier is added to the solution, to which water is then added, to prepare an aqueous dispersion by forced stirring. For example, an emulsion polymerization method comprises polymerizing under stirring at about 30° C. to about 100° C. (preferably 60° C. to 90° C.) for 3 to 24 hours by using water or a mixed solvent of water and a water-miscible organic solvent (such as methanol, ethanol, or acetone) as a dispersion medium, a monomer mixture in an amount of 5 mass % to 150 mass % based on the amount of the dispersion medium, an emulsifier and a polymerization initiator. Various conditions, such as the dispersion medium, the monomer concentration, the amount of initiator, the amount of emulsifier, the amount of dispersant, the reaction temperature, and the method for adding monomers, are suitably determined considering the type of the monomers to be used. Furthermore, it is preferable to use a dispersant when necessary.

<Solid dispersion>

The solid dispersion that can be used in the present invention is preferably prepared by adding to an aqueous coating solution. The dispersion is produced under the conditions by controlling, for example, the kind of a dispersing agent, the density or viscosity of a binder, the stirring conditions, the dispersing time, and the dispersing temperature, whereby the particle size can be made more homogeneous. However, a slight amount of coarse grains still remains in the emulsified dispersion, or coarse grains are formed by coalescence of grains during storage of the emulsified dispersion, which results in one of factors deteriorating the state of coated surface at the time of production of the heat-sensitive transfer image- receiving sheet.

In the heat-sensitive transfer image-receiving sheet of the present invention, a favorable coated surface state can be attained using solid dispersion having an average particle diameter of 1.0 μm or less. The coated surface state is further improved in the case where the average particle diameter is 0.6 μm or less. Especially preferred are solid dispersions of any of the compound represented by the above-described formula (L1), or wax such as microcrystalline wax, montan wax or carnauba wax. However, the present invention is not limited to theses materials. The solid dispersion according to the present invention can be used, by adding it to a coating solution which is produced by emulsifying and dispersing the solid dispersion making substances in a gelatin aqueous solution by using an anionic surface active agent, such as sodium dodecylbenzenesulfonate and sodium oleoylmethyltaurine. The emulsified dispersion can be produced according to a known method using tools, such as a homogenizer, dissolver, and Manton-Gaulin emulsifier. In the emulsified dispersion, use may be made of an additive(s), such as an auxiliary solvent and an antiseptics, in addition to the surface active agent.

An addition amount of the solid dispersion according to the present invention is preferably in the range of from 0.5 mass % to 30 mass %, more preferably in the range of from 1 mass % to 20 mass %, and furthermore preferably in the range of from 1.5 mass % to 15 mass %, based on the total solid content of the receptive layer In the heat-sensitive transfer image-receiving sheet of the present invention, an average particle diameter of the entire solid dispersions contained in coating liquids for forming constitutional layers on the same side as the dye-receptive layer on the support, is preferably 1.0 μm or less, more preferably 0.7 μm or less, most preferably 0.5 μm or less. The lower limit of the aforementioned average particle diameter is not particularly limited, but it is generally 0.05 μm or more.

In the heat-sensitive transfer image-receiving sheet of the present invention, in terms of particle diameter of the entire solid dispersions contained in coating liquids for forming constitutional layers on the same side as the dye-receptive layer on the support, the number of particles of not less than 10 μm is preferably 1/500 or less, more preferably 1/1,000 or less, with respect to the total particle numbers. The lower limit of the aforementioned number of particles is not particularly limited, but it is generally 1/10,000 or more.

<Water-soluble polymer>

The receptive layer preferably contains a water-soluble polymer. The water-soluble polymer which can be used in the present invention is any of natural polymers (polysaccharide type, microorganism type, and animal type), semi-synthetic polymers (cellulose-based, starch-based, and alginic acid-based), and synthetic polymer type (vinyl type and others); and synthetic polymers including polyvinyl alcohols, and natural or semi-synthetic polymers using celluloses derived from plant as starting materials, which will be explained later, correspond to the water-soluble polymer usable in the present invention. The latex polymers recited above are not included in the water-soluble polymers which can be used in the present invention. In the present invention, the water-soluble polymer is also referred to as a binder, for differentiation from the latex polymer described above.

Herein, the “water-soluble polymer” means a polymer which dissolves, in 100 g water at 20° C., in an amount of preferably 0.05 g or more, more preferably 0.1 g or more, further preferably 0.5 g or more, and particularly preferably 1 g or more.

Preferred binders are transparent or semitransparent, and generally colorless. Examples include natural resins, polymers and copolymers; synthetic resins, polymers, and copolymers; and other media that form films: for example, rubbers, polyvinyl alcohols, hydroxyethyl celluloses, cellulose acetates, cellulose acetate butylates, polyvinylpyrrolidones, starches, polyacrylic acids, polymethyl methacrylates, polyvinyl chlorides, polymethacrylic acids, styrenelmaleic acid anhydride copolymers, styrene/acrylonitrile copolymers, styrenelbutadiene copolymers, polyvinylacetals (e.g., polyvinylformals and polyvinylbutyrals), polyesters, polyurethanes, phenoxy resins, polyvinylidene chlorides, polyepoxides, polycarbonates, polyvinyl acetates, polyolefins, cellulose esters, and polyamides. These media are water-soluble.

In the present invention, preferred water-soluble polymers are polyvinyl alcohols and gelatin, with gelatin being most preferred.

The amount of the water-soluble polymer to be added to the receptive layer is preferably from 1 to 25% by mass, more preferably from 1 to 10% by mass, based on the entire mass of the receptive layer.

<Hardening agent>

A hardening agent that is used in the present invention as a crosslinking agent, may be added to a coating layer of the image-receiving sheet, such as a receptive layer, a heat-insulating layer, and a subbing layer. Herein, the term “crosslinking agent” is also referred to as a compound or crosslinking agent capable of crosslinking a water-soluble polymer.

Preferable examples of the hardener that can be used in the present invention include H-1, 4, 6, 8, and 14 in JP-A-1-214845 in page 17; compounds (H-1 to H-54) represented by one of formulae (VII) to (XII) in U.S. Pat. No. 4,618,573, columns 13 to 23; compounds (H-1 to H-76) represented by formula (6) in JP-A-2-214852, page 8, the lower right (particularly, H-14); and compounds described in claim 1 in U.S. Pat. No. 3,325,287. Examples of the hardening agent include hardening agents described, for example, in U.S. Pat. No. 4,678,739, column 41, U.S. Pat. No. 4,791,042, JP-A-59-116655, JP-A-62-245261, JP-A-61-18942, and JP-A-4-218044. More specifically, an aldehyde-series hardening agent (formaldehyde, etc.), an aziridine-series hardening agent, an epoxy-series hardening agent, a vinyl sulfone-series hardening agent (N,N′-ethylene-bis(vinylsulfonylacetamido)ethane, etc.), an N-methylol-series hardening agent (dimethylol urea, etc.), a boric acid, a metaboric acid, or a polymer hardening agent (compounds described, for example, in JP-A-62-234157), can be mentioned.

Preferable examples of the hardener include a vinylsulfone-series hardener and chlorotriazines.

These hardening agents are used in an amount of generally 0.001 to 1 g, preferably 0.005 to 0.5 g, per g of the water-soluble polymer.

### <Emulsion>

The receptive layer of the heat-sensitive transfer image-receiving sheet of the present invention preferably contains an emulsion. The following is a detailed explanation of the emulsion that can be preferably used in the present invention.

Hydrophobic additives, such as an antioxidant, can be introduced into a layer of the image-receiving sheet (e.g. the receptive layer, the heat insulating layer, the undercoat layer) as an emulsion, by using a known method described in U.S. Pat. No. 2,322,027, or the like. In this case, a high-boiling point organic solvent, as described in U.S. Pat. No. 4,555,470, No. 4,536,466, No. 4,536,467, No. 4,587,206, No. 4,555,476 and No. 4,599,296, JP-B-3-62256, and the like, may be used singly or in combination with a low-boiling point organic solvent having a boiling point of 50 to 160° C., according to the need. Besides, these antioxidants, and high-boiling organic solvents may be respectively used in combination of two or more of those.

A content of the antioxidizing agent is preferably from 1.0 to 7.0 mass %, more preferably from 2.5 to 5.0 mass %, based on a solid content in the latex polymer.

<Releasing agent >

In the receptive layer, for prevention from heat seal with a thermal transfer sheet at the time of image formation, the releasing agent may be blended. As the releasing agent, use may be made of any of silicone oil, phosphoric acid ester-series plasticizers, and fluorine compounds. Silicone oil is preferably used in particular. As the silicone oil, use may be preferably made of various modified silicone oil, such as those modified with any groups of epoxy, alkyl, amino, carboxyl, alcohol, fluorine, alkyl aralkyl polyether, epoxy polyether, or polyether. Of these modified silicone oils, it is preferred to use a reaction product of a vinyl modified silicone oil with a hydrogen modified silicone oil.

As the silicone oil as the lubricant, straight silicone oil and modified silicone oil or their hardened products may be used. Examples of the straight silicone oil include dimethylsilicone oil, methylphenylsilicone oil, and methyl hydrogen silicone oil. Examples of the dimethylsilicone oil include KF96-10, KF96-100, KF96-1000, KF96H-10000, KF96H-12500, and KF96H-100000 (trade names, manufactured by Shin-Etsu Chemical Co., Ltd.). Examples of the methylphenylsilicone oil include KF50-100, KF54, and KF56 (trade names, manufactured by Shin-Etsu Chemical Co., Ltd.).

<Ultraviolet absorber>

Besides, in the present invention, in order to improve light resistance, an ultraviolet absorber may be added to the receptive layer. In this case, when this ultraviolet absorber is made to have a higher molecular mass, it can be secured to the receptive layer so that it can be prevented, for instance, from being diff-used into the ink sheet and from being sublimated and vaporized by heating.

As the ultraviolet absorber, compounds having various ultraviolet absorber skeletons, which are widely known in the field of information recording, may be used. Specific examples of the ultraviolet absorber may include compounds having a 2-hydroxybenzotriazole-type ultraviolet absorber skeleton, 2-hydroxybenzotriazine-type ultraviolet absorber skeleton, or 2-hydroxybenzophenon-type ultraviolet absorber skeleton. Compounds having a benzotriazole-type or triazine-type skeleton are preferable from the viewpoint of ultraviolet absorbing ability (absorption coefficient) and stability, and compounds having a benzotriazole-type or benzophenone-type skeleton are preferable from the viewpoint of obtaining a higher-molecular mass and using in a form of a latex. Specifically, ultraviolet absorbers described in, for example, JP-A-2004-361936 may be used.

The addition amount of the ultraviolet-absorber-grafted polymer or its latex is preferably 5 to 50 parts by mass, more preferably 10 to 30 parts by mass, to 100 parts by mass of the dyeable receptive latex polymer capable of forming the receptive layer.

The amount of the receptive layer to be applied is preferably 0.5 to 10 g/m² (solid basis, hereinafter, the amount to be applied in the present specification means a value on solid basis, unless otherwise specified), more preferably 1 to 8 g/m², and further preferably 2 to 7 g/m². The film thickness of the receptive layer is preferably 1 to 20 μm.

### (Heat Insulating Layer)

A heat insulating layer serves to protect the support from heat when a thermal head or the like is used to carry out a transfer operation under heating. Besides, because the heat insulating layer generally has proper cushion characteristics, a heat-sensitive transfer image-receiving sheet having high printing sensitivity can be obtained even in the case of using paper as a support. The heat insulating layer may be a single layer, or multi-layers. The heat insulating layer is generally arranged at a nearer location to the support than the receptive layer.

Examples of the heat insulating layers include ones containing hollow polymer particles. The hollow polymer particles in the present invention are polymer particles having independent pores inside of the particles. Examples of the hollow polymer particles include (1) non-foaming type hollow particles obtained in the following manner: a dispersion medium, such as water, is contained inside of a capsule wall formed of a polystyrene, acrylic resin, or styrene/-acrylic resin, and, after a coating solution is applied and dried, the dispersion medium in the particles is vaporized out of the particles, with the result that the inside of each particle forms a hollow; (2) foaming type microballoons obtained in the following manner: a low-boiling point liquid, such as butane and pentane, is encapsulated in a resin constituted of any one of polyvinylidene chloride, polyacrylonitrile, polyacrylic acid, and polyacrylate, or their mixture or polymer, and after the resin coating material is applied, it is heated to expand the low-boiling point liquid inside of the particles, whereby the inside of each particle is made to be hollow, and (3) microballoons obtained by foaming the above (2) under heating in advance, to make hollow polymer particles.

The heat insulating layer preferably contains at least one water-soluble polymer, such as gelatin or polyvinyl alcohol. The amount of the water-soluble polymer, such as gelatin, in the coating solution for the heat insulating layer is preferably 0.5 to 14% by mass, and particularly preferably 1 to 6% by mass. Besides, the coating amount of the above hollow polymer particles in the heat insulating layer is preferably I to 100 g/m², and more preferably 5 to 20 g/m².

The water-soluble polymer that is contained in the heat insulating layer has been preferably cross-linked by the crosslinking agent. Preferable compounds as well as a preferable amount of the crosslinking agent to be used are the same as mentioned above.

A preferred ratio of a cross-linked water-soluble polymer to the heat insulating layer varies depending on the kind of the crosslinking agent, but the water-soluble polymer in the heat insulating layer is crosslinked preferably to the extent of 0.1 to 20 mass %, more preferably to the extent of 1 to 10 mass %, based on the entire water-soluble polymer.

A thickness of the heat insulating layer containing the hollow polymer particles is preferably from 5 to 50 μm, more preferably from 5 to 40 μm.

### (Undercoat Layer)

An undercoat layer may be formed between the receptive layer and the heat insulating layer. As the undercoat layer, for example, a white background controlling layer, a charge-controlling layer, an adhesive layer, and a primer layer is formed. These layers may be formed in the same manner as those described in, for example, each specification of Japanese Patent Nos. 3585599 and 2925244.

### (Support)

As the support, use may be made of any kind of hitherto known supports, and no limitation is imposed thereto, but it is preferred in the present invention to use a water-proof support. The use of the waterproof support makes it possible to prevent the support from absorbing moisture, whereby a fluctuation in the performance of the receptive layer with the lapse of time can be prevented. As the waterproof support, for example, coated paper or laminate paper may be used.

### Coated Paper

The coated paper is paper obtained by coating a sheet, such as base paper, with any of various resins, rubber latexes, or high-molecular materials, on one side or both sides of the sheet, in which the coating amount differs depending on its use. Examples of such coated paper include art paper, cast coated paper, and Yankee paper.

It is preferable to use a thermoplastic resin as the resin to be applied to the surface(s) of the base paper and the like. Epoxy resins, and phenolic resins may be exemplified.

The thermoplastic resins may be used either singly or in combination of two or more of those.

The thermoplastic resin may contain a whitener, a conductive agent, a filler, a pigment or dye including, for example, titanium oxide, ultramarine blue, and carbon black; or the like, if necessary.

### Laminated Paper

The laminated paper is a paper which is formed by laminating any of various kinds of resins, rubbers, polymer sheets or films, on a sheet, such as a base paper or the like. Specific examples of the materials useable for the lamination include polyolefins, polyvinyl chlorides, polyethylene terephthalates, polystyrenes, polymethacrylates, polycarbonates, polyimides, and triacetylcelluloses. These resins may be used either singly or in combination of two or more of those.

Generally, the polyolefins are prepared by using a low-density polyethylene, in many cases. In the present invention, however, for improving the thermal resistance of the support, it is preferred to use a polypropylene, a blend of a polypropylene and a polyethylene, a high-density polyethylene, or a blend of a high-density polyethylene and a low-density polyethylene. From the viewpoint of cost and its suitableness for the lamination, it is particularly preferred to use the blend of a high-density polyethylene and a low-density polyethylene.

The thickness of the support is preferably from 25 μm to 300 μm, more preferably from 50 μm to 260 μm, and further preferably from 75 μm to 220 μm. The support can have any rigidity according to the purpose. When it is used as a support for electrophotographic image-receiving sheet of photographic image quality, the rigidity thereof is preferably near to that in a support for use in color silver halide photography.

### (Curling-control Layer)

When the support is exposed as it is, there is the case where the heat-sensitive transfer image-receiving sheet is made to curl by moisture and/or temperature in the environment. It is therefore preferable to form a curling-control layer on the backside of the support. The curling-control layer not only prevents the image-receiving sheet from curling but also has a water-proof function. For the curling-control layer, a polyethylene laminate, a polypropylene laminate, or the like is used. Specifically, the curling-control layer may be formed in a manner similar to those described in, for example, JP-A-61-110135 and JP-A-6-202295.

### (Writing Layer and Charge-controlling Layer)

For the writing layer and the charge-control layer, an inorganic oxide colloid, an ionic polymer, or the like may be used. As the antistatic agent, use may be made of any antistatic agents including cationic antistatic agents, such as a quaternary ammonium salt and polyamine derivative, anionic antistatic agents, such as alkyl phosphate, and nonionic antistatic agents, such as fatty acid ester. Specifically, the writing layer and the charge-control layer may be formed in a manner similar to those described in the specification of Japanese Patent No. 3585585.

The method of producing the heat-sensitive transfer image-receiving sheet of the present invention is explained below.

The heat-sensitive transfer image-receiving sheet of the present invention can be preferably formed, by applying at least one receptive layer, at least one intermediate layer, and at least one heat-insulating layer, on a support, through simultaneous multi-layer coating.

It is known that in the case of producing an image-receiving sheet composed of plural layers having different functions from each other (for example, an air cell layer, a heat insulating layer, an intermediate layer, and a receptive layer) on a support, it may be produced by applying each layer successively one by one, or by overlapping the layers each already coated on a support, as shown in, for example, JP-A-2004-106283, JP-A-2004-181888 and JP-A-2004-345267. It has been known in photographic industries, on the other hand, that productivity can be greatly improved, for example, by providing plural layers through simultaneous multi-layer coating. For example, there are known methods, such as the so-called slide coating (slide coating method) and curtain coating (curtain coating method), as described in, for example, U.S. Pat. Nos. 2,761,791, 2,681,234, 3,508,947, 4,457,256 and 3,993,019; JP-A-63-54975, JP-A-61-278848, JP-A-55-86557, JP-A-52-31727, JP-A-55-142565, JP-A-50-43140, JP-A-63-80872, JP-A-54-54020, JP-A-5-104061, JP-A-5-127305, and JP-B-49-7050; and Edgar B. Gutoff, ct al., “Coating and Drying Defects: Troubleshooting Operating Problems”, John Wiley & Sons, 1995, pp. 101-103; and “LIQUID FILM COATING”, CHAPMAN & HALL, 1997, pp. 401-536.

In the present invention, the productivity is greatly improved and, at the same time, image defects can be remarkably reduced, by using the above simultaneous multilayer coating for the production of an image-receiving sheet having a multilayer structure. Besides, more favorable stability of quality can be achieved by the above-described multilayer-coating in addition to the constitution of the heat-sensitive transfer image-receiving sheet according to the present invention.

In the present invention, the coating amount of a coating solution per one layer constituting the multilayer structure is preferably in the range from 1 g/m² to 500 g/m². The number of layers in the multilayer structure may be arbitrarily selected from a number of 2 or more. The receptive layer is preferably provided as a layer most apart from the support.

A heat-sensitive transfer sheet (an ink sheet) that is used in combination with the heat-sensitive transfer image-receiving sheet of the present invention as mentioned above, at the time of formation of a heat transfer image, is, for example, a sheet having on a support a dye layer containing a diffuision-transfer dye, and any ink sheet can be used as the sheet. As a means for providing heat energy in the thermal transfer, any of the known providing means may be used. For example, application of a heat energy of about 5 to 100 mJ/mm² by controlling the recording time in a recording device, such as a thermal printer (e.g., trade name: Video Printer VY-100, manufactured by Hitachi, Ltd.), sufficiently attains the expected result.

Besides, the heat-sensitive transfer image-receiving sheet of the present invention may be used in various applications enabling thermal transfer recording, such as heat-sensitive transfer image-receiving sheets in a form of thin sheets (cut sheets) or rolls; cards; and transmittable-type manuscript-making sheets, by appropriately selecting the type of support.

The present invention can be applied to a printer, a copying machine, and the like, each of which uses a heat-sensitive transfer recording system.

The present invention enables to provide an excellent image-forming heat-sensitive transfer image-receiving sheet owing to a drastically reduced surface state deficiency, as compared to the conventional image-receiving sheets, and a production method for such the improved heat-sensitive transfer image-receiving sheet.

The present invention will be described in more detail based on the following examples, but the invention is not intended to be limited thereto. In the following examples, the terms “part(s)” and “%” are values by mass, unless otherwise specified.

### EXAMPLES

### (Preparation of Ink Sheet)

A polyester film 6.0 μm in thickness (trade name: Lumirror, manufactured by Toray Industries, Inc.) was used as the substrate film. A heat-resistant slip layer (thickness: 1 μm) was formed on the back side of the film, and the following yellow, magenta, and cyan compositions were respectively applied as a monochromatic layer (coating amount: 1 g/m² after drying) on the front side of the film.

Yellow composition

| | |
|---|---|
| Yellow dye (trade name: Macrolex Yellow 6G, | 5.5 parts by mass |
| manufactured by Bayer) | |
| Polyvinylbutyral resin (trade name: ESLEC BX-1, | 4.5 parts by mass |
| manufactured by Sekisui Chemical Co., Ltd.) | |
| Methyl ethyl ketone/toluene (1/1, at mass ratio) | 90 parts by mass |

Magenta composition

| | |
|---|---|
| Magenta dye (trade name; Disperse Red 60) | 5.5 parts by mass |
| Polyvinylbutyral resin (trade name: ESLEC BX-1, | 4.5 parts by mass |
| manufactured by Sekisui Chemical Co., Ltd.) | |
| Methyl ethyl ketone/toluene (1/1, at mass ratio) | 90 parts by mass |

Cyan composition

| | |
|---|---|
| Cyan dye (Solvent Blue 63) | 5.5 parts by mass |
| Polyvinylbutyral resin (trade name: ESLEC BX-1, | 4.5 parts by mass |
| manufactured by Sekisui Chemical Co., Ltd.) | |
| Methyl ethyl ketone/toluene (1/1, at mass ratio) | 90 parts by mass |

### (Preparation of Image-Receiving Sheet)

(1) Preparation of Samples 101 to 117

### (Preparation of Support)

A pulp slurry was prepared from 50 parts by mass of hardwood bleach kraft pulp (LBKP) of acacia origin and 50 parts by mass of hardwood bleach kraft pulp (LBKP) of aspen origin, by beating these pulps by means of a disk refiner until Canadian standard freeness reached to 300 ml.

Then, to the pulp slurry thus prepared were added, on a pulp basis, 1.3 mass % of cationically-modified starch (CAT0304L, trade name, manufactured by Nippon NSC), 0.15 mass % of anionic polyacrylarnide (DA4104, trade name, manufactured by Seiko PMC Corporation), 0.29 mass % of an alkylketene dimer (SIZEPINE K, trade name, manufactured by Arakawa Chemical Industries, Ltd.), 0.29 mass % of epoxidated behenic acid amide, and 0.32 mass % of polyamide polyarnine epichlorohydrin (ARAFIX 100, trade name, manufactured by Arakawa Chemical Industries, Ltd.), and thereafter 0.12 mass % of a defoaming agent was further added.

The thus-prepared pulp slurry was made into paper by use of a fourdrinier paper machine. In a process of drying in which the felt side of web was pressed against a drum dryer cylinder via a dryer canvas, the web thus formed was dried under the condition that the tensile strength of the dryer canvas was adjusted to 1.6 kg/cm. Then, each side of the raw paper thus made was coated with 1 g/m² of polyvinyl alcohol (KL-118, trade name, manufactured by Kuraray Co., Ltd.) with a size press, followed by drying and further subjecting to calendering treatment. The papermaking was performed so that the raw paper had a grammage (basis weight) of 157 g/m², and the raw paper (base paper) of thickness 160 μm was obtained.

The wire side (back side) of the base paper obtained was subjected to corona discharge treatment, and thereto a resin composition, in which a high-density polyethylene of MFR (which stands for a melt flow rate, and hereinafter has the same meaning) 16.0 g/10-min and density 0.96 g/cm³ (containing 250 ppm of hydrotalcite (DHT-4A (trade name), manufactured by Kyowa Chemical Industry Co., Ltd.) and 200 ppm of a secondary oxidation inhibitor (tris(2,4-di-t-butylphenyl)phosphite, Irugaphos 168 (trade name), manufactured by Ciba Specialty Chemicals)) and a low-density polyethylene of MFR 4.0 g/l 0-min and density 0.93 g/cm³ were mixed at a ratio of 75 to 25 by mass, was applied so as to have a thickness of 21 g/m², by means of a melt extruder, thereby forming a thermoplastic resin layer with a mat surface. (The side to which this thermoplastic resin layer was provided is hereinafter referred to as “back side”). The thermoplastic resin layer at the back side was further subjected to corona discharge treatment, and then coated with a dispersion prepared by dispersing into water a 1:2 mixture (by mass) of aluminum oxide (ALUMINASOL 100, trade name, manufactured by Nissan Chemical Industries, Ltd.) and silicon dioxide (SNOWTEX 0, trade name, manufactured by Nissan Chemical Industries, Ltd.), as an antistatic agent, so that the coating would have a dry mass of 0.2 g/m². Then, the front surface (front side) of the base paper was subjected to corona discharge treatment, and then coated with a low-density polyethylene of MFR 4.0 g/l 0-min and density 0.93 g/m², containing 10 mass % of titanium oxide, by means of a melt extruder, so that the coating amount would be 27 g/m², thereby forming a thermoplastic resin layer with a specular surface.

### (Preparation of Emulsified Dispersion A)

An emulsified dispersion A was prepared in the following manner. An antioxidant (EB-9)(3,3,3′,3′-tetramethyl-5,5′,6,6′-tetrapropoxy-1,1′-spirobiindane) was dissolved in a mixture of 42 g of a high-boiling point solvent (Solv-5)(tris(isopropylphenyl)phospbate) and 20 ml of ethyl acetate, and the resultant solution was emulsified and dispersed in 250 g of a 20-mass % aqueous gelatin solution containing 1 g of sodium dodecylbenzenesulfonate, by means of a high-speed stirring emulsifier (dissolver). Thereto, water was added, to prepare 380 g of the emulsified dispersion A.

The addition amount of the antioxidant (EB-9) was adjusted so that the compound would be contained in an amount of 30 mmol in the emulsified dispersion A.

### (Preparation of Solid Dispersion B)

To 1.0 kg of the compound (L1-101) described above according to the present invention, were added 2.4 L of water, 30 ml of phenoxyethanol, 10 g of methyl p-hydroxybenzoate, and 1.0 kg of gelatin, to admix the resultant mixture, under stirring at 50° C. for 20 minutes. To the resultant mixture, 250 ml of a 10-mass % aqueous solution of sodium oleoylmethyltaurine was added, followed by stirring for 60 min at 5,000 rpm with dissolver, thereby to prepare an emulsified dispersion. To the thus-obtained emulsified dispersion, water of 40° C. was added, to make 10 kg of the final amount, thereby to give the Solid dispersion B . With respect to the thus-obtained dispersion, an average particle size and a ratio of the number of particles having a size of not less than 10 μm to the total particle numbers were measured using a light-scattering type particle size-measuring apparatus LA-920 manufactured by HORIBA. The thus-obtained results are shown in Table 2.

Then, solid dispersions C and D were prepared in the same manner as the solid dispersion B, except that the compound L1-101 used for the preparation of the solid dispersion B was replaced by an equivalent mass amount of the compound L1-104 or L1-105, as shown in Table 2 set forth in the below, respectively.

Further, solid dispersions E and F were obtained in the same manner as the solid dispersions B and D using the same compound as used for preparation of these solid dispersions, except that the Disolver agitating time was changed to 30 minutes. Similarly, solid dispersions G and H were obtained in the same manner as the solid dispersions B and D using the same compound as used for preparation of these solid dispersions, except that the Disolver agitating time was changed to 10 minutes.

Further, solid dispersions I and J (Disolver agitating time: 30 minutes) and solid dispersions K and L (Disolver agitating time: 8 minutes) were prepared in the same manner as above solid dispersions, except for using the compound set forth below. With respect to the thus-obtained dispersions, an average particle size and a ratio of the number of particles having a size of not less than 10 μm to the total particle numbers were measured using a light-scattering type particle size-measuring apparatus LA-920 manufactured by HORIBA.

The results are shown in Table 2.

| | |
|---|---|
| Compound-1 | |
| C₁₅H₃₁COOC₁₄H₂₉ | Molecular mass: 452 |
| Compound-2 | |
| RCOOH | Average molecular mass: ca. 450 |

R = an alkyl group having 28 to 32 carbon atom

Sample 101 was prepared by coating, on the support which had been prepared in the foregoing manner, to form a multilayer structure having a subbing layer 1, a subbing layer 2, a heat insulating layer, and a receptive layer, in increasing order of distance from the support.

The compositions and coated amounts of the coating solutions to be used are shown below.

The simultaneous multi-layer coating was carried out, according to the slide coating method described in the aforementioned “LIQUID FILM COATING”¹ p.427; and after coating, the thus-coated products were passed through a set zone at 6° C. for 30 seconds to lose fluidity, followed by drying by spraying a drying air at 22° C. and 45%RH on the coated surface for 2 minutes. Coating solution for subbing layer 1

| | |
|---|---|
| (Composition) | |
| Aqueous solution, prepared by adding 1% of sodium | |
| dodecylbenzenesulfonate | |
| to a 3% aqueous gelatin solution | |
| NaOH for adjusting pH to 8 | |
| (Coating amount) | 11 ml/m² |

Coating solution for subbing layer 2

| | |
|---|---|
| (Composition) | |
| Styrene-butadiene latex (SR103 (trade name), | 60 parts by mass |
| manufactured by Nippon A & L Inc.) | |
| 6% Aqueous solution of polyvinyl alcohol (PVA) | 40 parts by mass |
| NaOH for adjusting pH to 8 | |
| (Coating amount) | 11 ml/m² |

Coating solution for heat insulating layer

| | |
|---|---|
| (Composition) | |
| Hollow latex polymer particles (MH5055 (trade name), | 60 parts by mass |
| manufactured by Nippon Zeon Corporation) | |
| 10% Gelatin aqueous solution | 20 parts by mass |
| Emulsified dispersion A prepared in the above | 20 parts by mass |
| NaOH for adjusting pH to 8 | |
| (Coating amount) | 45 ml/m² |

Coating solution for receptive layer 1

| | |
|---|---|
| (Composition) | |
| Vinyl chloride-latex polymer (VINYBLAN 900 | 85 parts by mass |
| (trade name), manufactured by Nissin | |
| Chemical Industry Co., Ltd.) | |
| Vinyl chloride-latex polymer (VINYBLAN 276 | 50 parts by mass |
| (trade name), manufactured by Nissin | |
| Chemical Industry Co., Ltd.) | |
| Solid dispersion B | 20 parts by mass |
| Water | 14 parts by mass |
| NaOH for adjusting pH to 8 | |
| (Coating amount) | 18 ml/m² |

Samples 102 to 111 were prepared in the same manner as Sample 101, except that the above-described solid dispersions C to L were used, respectively, in place of the solid dispersion B. Further, Samples 112 was prepared in the same manner as above samples, except for using a solid dispersion in which the solid dispersions B and L were mixed so as to become a ratio by mass of 8 to 2.

Further, multilayered structure coated Samples 113, 114 and 115 were prepared in the same manner as above, expect for using a microcrystalline wax EMUSTER 042X (trade name, average particle size 0.5 μm) manufactured by NIPPON SEIRO, a montan wax J537 (trade name, average particle size 0.5 μm) manufactured by CHUKYO YUSHI, and a carnauba wax SEROSOL 524 (trade name, average particle size 0.2 μm) manufactured by CHUKYO YUSHI, respectively, in place of the above solid dispersions. In those, the solid content of the wax added to each of these coated samples was adjusted so as to become the same amount as that of the solid dispersion of the above-described samples.

Sample 116 was prepared in the same manner as Sample 101 , except for omitting addition of the solid dispersion.

Sample 117 was prepared in the same manner as Sample 101, except for using the heat-insulating layer-coating liquid set forth below. A coating amount of the heat-insulating layer was adjusted so as to become the same coating amount of solid content as the sample 101.

Coating solution for heat insulating layer of Sample 117

| | |
|---|---|
| Gelatin | 25 parts by mass |
| Water | 250 parts by mass |

### (Evaluation of Surface State and Image)

With respect to the above-described coated samples 101 to 117, the coated surface state was evaluated with the naked eye. A level of the surface state was determined in terms of size and number of cissing and contaminant.

The above-described ink sheet and the image-receiving sheet that was any one of the above-described samples 101 to 117 were processed so that they become loadable in a sublimation type printer ASK 2000 (trade name) manufactured by FUJI FILM Corporation. Then, 5 sheets of solid image with the maximum density were output in a high speed print mode. The surfaces of the thus-printed images were examined to evaluate a degree of unevenness owing to cissing and contaminant.

### Rank of Evaluation

5. Neither cissing nor contaminant (unevenuless in the case of a printed surface) is found, so that there is completely no problem.
4. The cissing and contaminant (unevenness in the case of a printed surface) recognizable with the naked eye with difficulty are found on rare occasions, so that there is no problem.
3. The cissing and contaminant (unevenness in the case of a printed surface) recognizable with the naked eye are slightly found, so that there is no problem in practice.
2. The cissing and contaminant (unevenness in the case of a printed surface) recognizable with the naked eye are sparsely found, so that a problem sometimes arises in practice.
1. A degree of cissing and contaminant (unevenness in the case of a printed surface) is too serious to use the output print.

TABLE 2

| | | Particle | | | |
|---|---|---|---|---|---|
| Sample No. | Solid dispersion | size (μm) | Surface state | Ratio of particles of size 10 μm or more | Remarks |
| 101 | B | 0.22 | 5 | <1/1000 | This invention |
| 102 | C | 0.23 | 5 | <1/1000 | This invention |
| 103 | D | 0.23 | 5 | <1/1000 | This invention |
| 104 | E | 0.65 | 4 | 1/500 to 1/1000 | This invention |
| 105 | F | 0.7 | 4 | 1/500 to 1/1000 | This invention |
| 106 | G | 1.08 | 2 | | Comparative example |
| 107 | H | 1.11 | 2 | | Comparative example |
| 108 | I | 0.34 | 4 | 1/500 to 1/1000 | This invention |
| 109 | J | 0.36 | 4 | 1/500 to 1/1000 | This invention |
| 110 | K | 1.51 | 1 | | Comparative example |
| 111 | L | 1.63 | 1 | | Comparative example |
| 112 | B:L = 8:2 | 0.42 | 3 | to 1/400 | This invention |
| 113 | Microcrystalline | 0.5 | 4 | 1/500 to 1/1000 | This invention |
| | wax EMUSTER | | | | |
| | 042X | | | | |
| 114 | Montan wax J537 | 0.5 | 4 | 1/500 to 1/1000 | This invention |
| 115 | Carnauba wax | 0.2 | 5 | <1/1000 | This invention |
| | SEROSOL 524 | | | | |
| 116 | Not added | — | 5 | | Comparative example |
| 117 | B | 0.22 | 5 | <1/1000 | This invention |

The surface state of sample 117 was almost equivalent to that of Sample 101. However, when they were printed on the same printing condition, sensitivity of Sample 117 was quite lower than that of Sample 101.

As described and demonstrated in the above, according to the heat-sensitive transfer image-receiving sheet of the present invention, it is possible to drastically reduce surface state deficiency, due to heat seal with an ink sheet, as compared to the conventional heat-sensitive transfer image-receiving sheet. Thus, according to the present invention, the heat-sensitive transfer image-receiving sheet, which can give an excellent image, can be provided; and also the method of producing the heat-sensitive transfer image-receiving sheet can be provided.

Having described our invention as related to the present embodiments, it is our intention that the invention not be limited by any of the details of the description, unless otherwise specified, but rather be construed broadly within its spirit and scope as set out in the accompanying claims.

What is claimed is:

1. A heat-sensitive transfer image-receiving sheet, comprising, on a support, at least one dye-receptive layer containing latex polymer and at least one heat-insulating layer, at least said receptive layer and a layer adjacent thereto being formed by a water-based simultaneous multilayer coating method, wherein said sheet contains at least one solid dispersion having an average particle diameter of 1.0 μm or less of at least one material selected from a compound represented by formula (L1) and wax: Formula (L1) 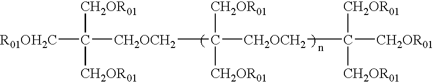
wherein R₀₁ represents —C(═O)R or a hydrogen atom, in which R represents an aliphatic group which may have a substituent, and a plurality of Rol's are the same as or different from each other, but at least one of R₀₁'s is —C(═O)R; and n represents 0 or 1.

2. The heat-sensitive transfer image-receiving sheet as claimed in claim 1, wherein an average particle diameter of the entire solid dispersions contained in coating liquids for forming constitutional layers on the same side as the dye-receptive layer on the support is 1.0 μm or less.

3. The heat-sensitive transfer image-receiving sheet as claimed in claim 1, wherein in terms of particle diameter of the entire solid dispersions contained in coating liquids for forming constitutional layers on the same side as the dye-receptive layer on the support, the number of particles of not less than 10 μm is 11500 or less with respect to the total particle numbers.

4. The heat-sensitive transfer image-receiving sheet as claimed in claim 1, wherein said dye-receptive layer contains latex polymer containing at least one recurring unit obtained from vinyl chloride.

5. The heat-sensitive transfer image-receiving sheet as claimed in claim 1, wherein said latex polymer of the dye-receptive layer is latex polymer containing at least one recurring unit obtained from vinyl chloride and at least one recurring unit obtained from acrylic acid ester.

6. The heat-sensitive transfer image-receiving sheet as claimed in claim 1, wherein said at least one heat-insulating layer on the support contains hollow polymer particles.

7. The heat-sensitive transfer image-receiving sheet as claimed in claim 1, wherein said heat-insulating layer contains at least one water-soluble polymer.

8. The heat-sensitive transfer image-receiving sheet as claimed in claim 7, wherein said water-soluble polymer is gelatin or polyvinyl alcohol.
